(19) United States
(12) Patent Application Publication
(10) Pub. No.: US 2012/0035963 A1
(43) Pub. Date: Feb. 9, 2012

(54) SYSTEM THAT AUTOMATICALLY RETRIEVES REPORT TEMPLATES BASED ON DIAGNOSTIC INFORMATION

(75) Inventors: Yuechen Qian, Eindhoven (NL); Helko Lehmann, Aachen (DE); Juergen Weese, Aachen (DE); Merlijn Sevenster, Amsterdam (NL); Eric Zachary Silfen, Andoveer, MA (US); Sabri Boughorbel, Eindhoven (NL)

(73) Assignee: KONINKLIJKE PHILIPS ELECTRONICS N.V., EINDHOVEN (NL)

(21) Appl. No.: 13/260,472

(22) PCT Filed: Feb. 11, 2010
(86) PCT No.: PCT/IB2010/050639

§ 371 Date: Sep. 26, 2011

Related U.S. Application Data
(60) Provisional application No. 61/163,602, filed on Mar. 26, 2009.

(51) Int. Cl. G06Q 50/24

(52) U.S. Cl. 705/3

(57) ABSTRACT

When generating radiology reports, image findings and/or clinical information is automatically mapped to an appropriate standardized structured report template. The report template contains placeholders for information such as case-specific images and measureable values, and the placeholders are filled in by either the radiologist or by automatic procedures such as image processing algorithms, text extraction algorithms, or the like. In this manner, the radiologist is assisted in effectively generating a reader-independent high-quality diagnostic report.

### DESCRIPTION

The present application finds particular utility in medical data storage and medical report generation systems. However, it will be appreciated that the described technique(s) may also find application in other types of report generation systems, data aggregation systems, and/or medical data storage systems.

A radiological report generated during the course of a radiology workflow typically includes procedures, findings, and conclusions. Such reports are dictated by radiologists and then transcribed to text by assistants or the like. The transcribed text reports are sent to referral clinicians to assist in their decision making. It is a primary concern of radiologists to provide high quality text reports.

In radiological reports, findings are used to support conclusions. A diagnostic conclusion is often based on the review of multiple images generated using different imaging modalities and/or protocols, the review of multiple anatomies in images, and the recognition of several findings. A given diagnosis may be rapidly identified by a radiologist, after years of their practice; providing detail in a text report regarding how the diagnosis is made, however, is very time consuming and person-dependent.

Increasing detail in the report, in a standardized and structured fashion, not only helps referral clinicians to better assess patient cases, but also assists care-givers (e.g., hospital administration and fellow radiologists) to verify the quality of radiological diagnosis. However, there are myriad diagnoses and their variants, making it difficult for a radiologist to remember what information should be written in the report for every diagnosis.

There is a need in the art for systems and methods that facilitate overcoming the deficiencies noted above by generating and storing retrievable report templates with information placeholders that are filled in to customize individual reports.

In accordance with one aspect, a medical report generation system includes a patient medical record database that stores one or more patient records, a text extraction component that extracts, structures, and encodes clinical information in the one or more patient records, and a reasoning engine that analyzes the extracted clinical information, identifies a reason for a medical report generation request, analyzes the one or more patient images, and suggests a pre-generated report template based on the identified reason. The system further includes an information integration component that integrates patient-specific information and background information into the report template in pre-specified fields to generate a custom report.

According to another aspect, a method of generating a custom radiology report using includes extracting textual information related to reasons for generating the report from received clinical and diagnostic information, performing a table lookup to identify an appropriate report template based on the extracted textual information, and identifying image features in a patient image. The method further includes detecting and classifying one or more lesions in the patient image using the identified image features, and inserting image feature information and extracted textual information into the report template at pre-specified placeholders

One advantage is that radiological reports are generated in less time.

Another advantage resides in increasing report detail without increasing report generation time.

Still further advantages of the subject innovation will be appreciated by those of ordinary skill in the art upon reading and understand the following detailed description.

The innovation may take form in various components and arrangements of components, and in various steps and arrangements of steps. The drawings are only for purposes of illustrating various aspects and are not to be construed as limiting.

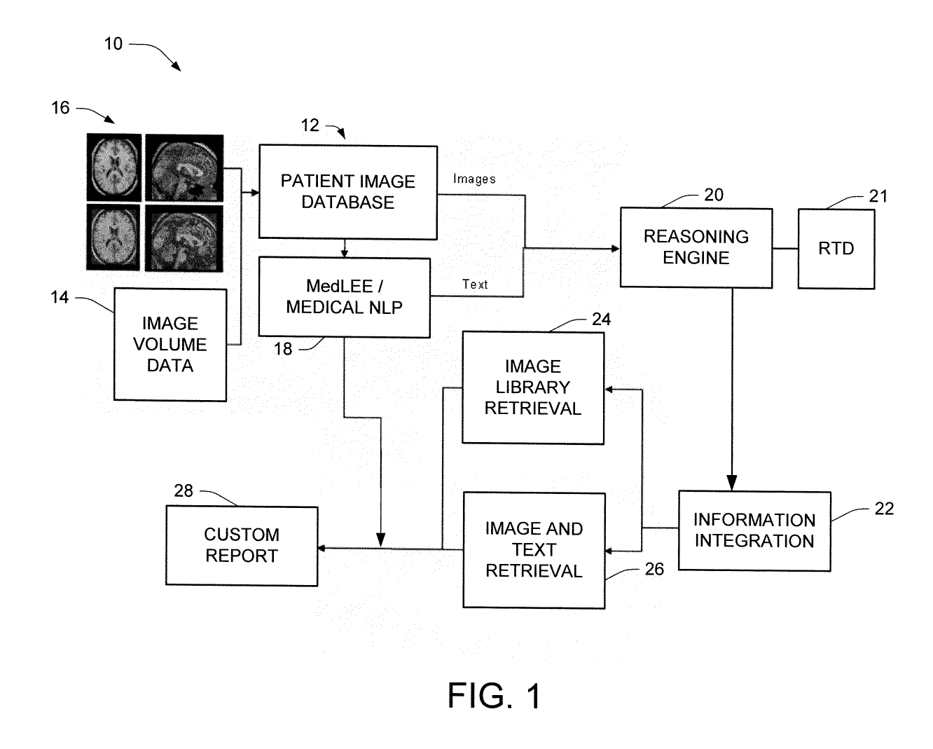

FIG. 1 illustrates a system that automatically maps image findings and/or clinical information to an appropriate standardized structured report template.

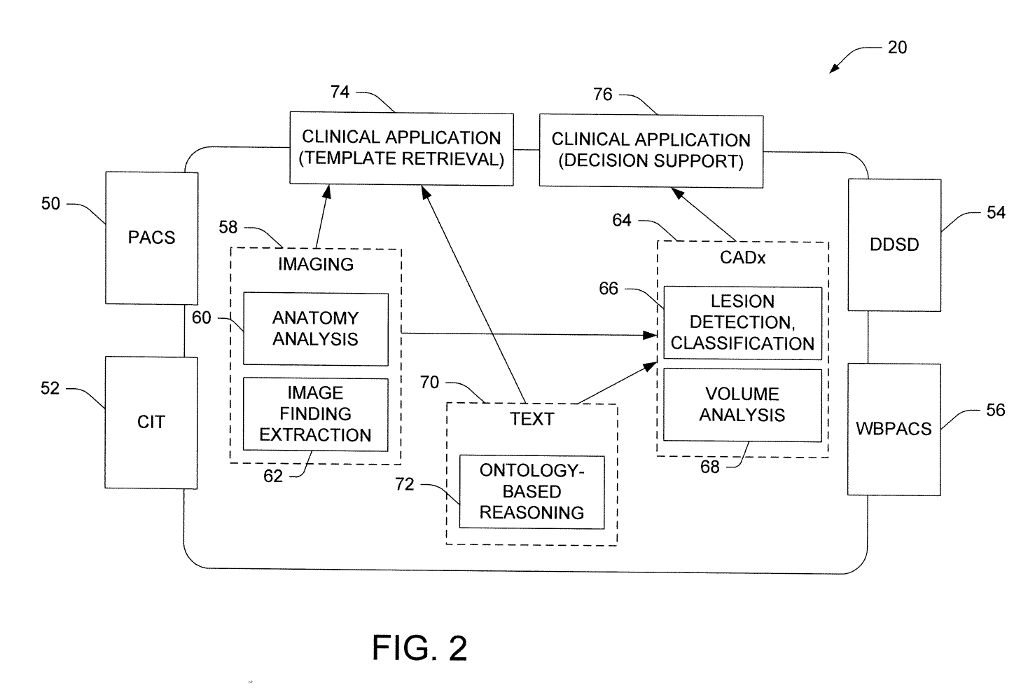

FIG. 2 is an illustration of the reasoning engine, which receives patient-specific information and infers or identifies a suitable report template for a desired medical report.

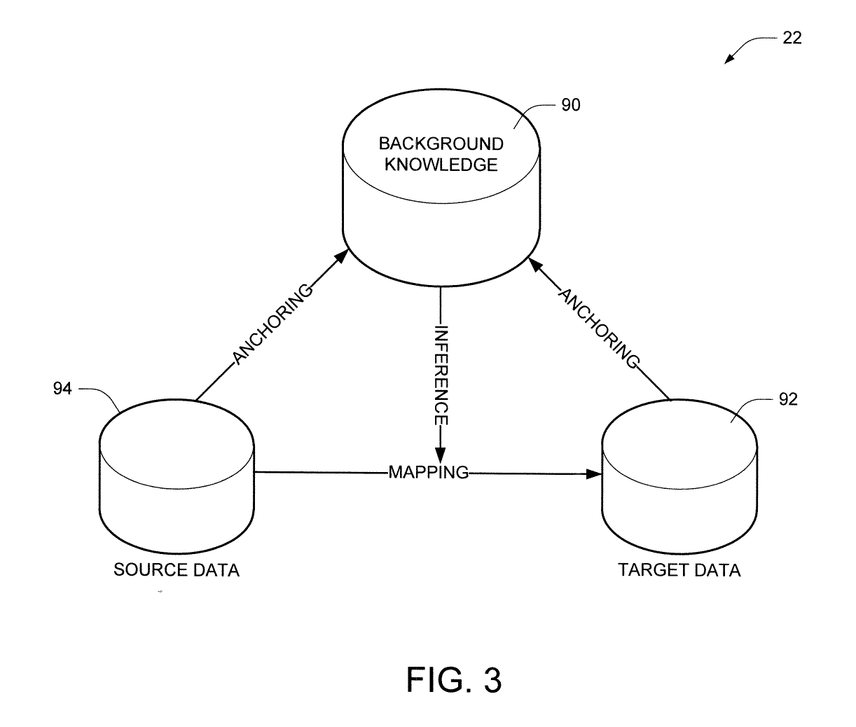

FIG. 3 is an illustration of the information integration component, which integrates patient specific information such as patient images, extracted text from medical records, user-entered information, and the like with reference information such as web links, encyclopedic information, etc., germane to the report.

FIG. 1 illustrates a system 10 that automatically maps image findings and/or clinical information to an appropriate standardized structured report template. The report template contains placeholders for information such as case-specific images and measureable values, to be filled in by either the radiologist or via automatic procedures, such as image processing algorithms. The system assists the radiologist in effectively generating a reader-independent high-quality diagnostic report.

The system allows a user to generate radiologist reports in fixed formats.

For instance, a plurality of templates are generated, one for each disease or type of study. After a radiologist generates diagnostic images and is ready to generate the report, the system 10 employs patient identification information to search hospital records and determine the type of study that was ordered and/or reasons therefor, retrieve the appropriate report template, and pre-populate the template with information from the hospital database, such as patient name and identification, nature of the diagnostic study, dates, etc. Further, the system 10 searches a database of diagnostic images to find standard images for the identified type of study or report and imports the standardized images into pre-designated placeholders or fields in the template. Where appropriate, the system also retrieves previously generated images of the patient to generate a series of time-line images showing the temporal progress of the therapy. The template includes links to literary references, e.g., with a web link to source articles, links to original image data, or other studies, and other interpretive information.

The template prompts the diagnostician to place analysis information in appropriate locations or fields, to make appropriate diagnostic interpretations, make appropriate measurements, and the like. Based on the analysis, the template may directly set up, or prompt the radiologist to set up, recommended future studies or reports, recommend further treatment, or the like.

In addition to simplifying the interpretation of the data by standardizing data format, storing this information, raw data, and analyses in a standardized format, the system also facilitates data mining The standardized format facilitates and expedites analysis of various treatments to permit generation of better treatment protocols by looking at the success or failure of prior treatments.

The system 10 includes an image database 12 that receives and stored image data, such as image volume data 14 and/or medical image data 16 generated using one or more imaging devices. For instance, image data can be generated using an x-ray device, a computed tomography (CT) imaging device, a nuclear imaging device such as a positron emission tomography (PET) scanner or a single photon emission computed tomography (SPECT) scanner, a magnetic resonance imaging (MRI) device, an ultrasound imaging device, variants of the foregoing devices, or any other suitable imaging device, such as a camera or the like. For example, tissue samples may be digitally photographed and stored as image data.

The system further includes a text extraction component 18 (e.g., a medical language extraction and encoding (MedLEE) system, a medical natural language processing (NLP) system, etc.) that extracts text from one or more medical databases, or patient records or references therein. In one embodiment, the text extraction component 18 extracts, structures, and encodes clinical information in textual patient reports so that the data can be used by subsequent automated processes.

A reasoning engine 20 receives image data from the image database 12 and extracted, structured, and encoded text from the text extraction component 18. In one embodiment, the reasoning engine 20 receives the images and/or the extracted or processed text data from one or more databases (e.g., a picture archiving and communication system database, a Center for Information Technology medical database, a diagnostic decision support database, a web-based picture archiving and communication system, etc.) accessible to the reasoning engine. The reasoning engine 20 analyzes clinical information (e.g., patient signs/symptoms, reasons for the report or study, etc.) to infer an appropriate report template to use. In another embodiment, the reasoning engine 20 is queried using clinical information (e.g., a combination of the patient's signs/symptoms, reasons for the study or report, etc.) and diagnostic information (a combination of image-findings, anatomical descriptions, and hypothesized disorders, etc.). The reasoning engine 20 replies with, or otherwise identifies, one or more query-specific report templates retrieved from a report template database (RTD) 21.

In one embodiment, the RTD 21 comprises a template for each of a plurality of diseases, diagnoses, medical studies, or the like, and the reasoning engine retrieves a specific template based on the clinical and diagnostic information. For instance, if the clinical information includes text descriptive of a tumor in a patients liver, then the reasoning engine can perform a table lookup on a lookup table in the RTD 21 to identify a template corresponding to “liver” and “tumor” or variants thereof (e.g., hepatic tumor, hepatic lesion, etc.). The selected template is then pre-populated with text from the clinical and/or diagnostic information.

The reasoning engine 20 identifies relevant information for entry into pre-specified fields in the report template. For instance, the reasoning engine can identify appropriate text from the extracted text information describing the reason for generating the report (e.g., for therapy planning, for clinician referral, for diagnosis, etc.). Additionally, the reasoning engine 20 extracts image findings (e.g., relevant image information) germane to an identified report template.

An information integration component 22 integrates the identified relevant text and image information into the identified report template, and accesses an image library 24 to retrieve standard images germane to the report. For instance, if the report is a radiology report describing diagnosis of a patient with a lesion or tumor in an organ, then the information integration component 22 retrieves standardized or “normal” image(s) of the organ in which the tumor is found for inclusion in the report. The normal organ image is then inserted into the report template in a pre-specified field or placeholder for comparison to an image of the patient's organ (e.g., identified or retrieved from the image database 12 by the reasoning engine 20), by the reasoning engine 20.

The system 10 additionally includes an image-and-text (IAT) retrieval component 26 that is accessed by the information integration component 22 to retrieve textual information, and associated images for insertion into the template. In one embodiment, the IAT retrieval component 26 includes a database of web links, textbook pages or chapters, etc., that have information relevant to the report, and the information itself or links thereto are inserted into the report template.

In one example, the information integration component 22 populates fields in the report template based on information provided in the query, and using additional information from an encyclopedia or databases containing reference cases/images, such as images from the image library 24 and/or text and images from the IAT component 26 or library. Such information can include reference images (e.g., from “gold-standard” cases) with corresponding descriptions, or any kind of data that is relevant to help the radiologists to fill out the report.

A custom report 28 is then generated using the information collected and inserted by the information integration component. The custom report 28 can include, for example, clinical information entered by a clinician or physician into a hospital database or records system, differential diagnosis information, substantiating information, annotating information (e.g., pathology information, bibliographical information, imaging information, etc.), etc. Any unpopulated or blank fields are then filled out either by the radiologist or by automatic processes that perform measurements.

According to one embodiment, the reasoning engine 20 receives descriptive information including reasons pertaining to why a particular study (e.g., an imaging study such as a CT scan, an MRI scan, a nuclear scan, an ultrasound, a histology, etc.) has been requested or performed. Relevant information (e.g., reasons for the study) is extracted from the text by the text extraction component 18, and provided to the reasoning engine 20 for this purpose. Optionally, the reasoning engine suggests one or more imaging techniques or protocols based on the extracted text information. The reasoning engine 20 retrieves an appropriate report template based on the received extracted text information. Additionally, or alternatively, the reasoning engine analyzes patient images (e.g., CT, X-ray, PET, SPECT, ultrasound, photographs, MR images, etc.) to identify relevant information (e.g., anatomical landmarks, etc.), and compares the identified image information to placeholders in the templates to select an appropriate template. For instance, if a patient image has a feature X, and symptoms Y and Z are determined from the clinical information (e.g., patient records or the like), then a template for a disease that corresponds to feature X and symptoms Y and Z is retrieved.

Once the report template has been identified, the reasoning engine 20 identifies relevant information in the patient images and medical records, and invokes the information integration component 22, populates the report template with the identified information. The information integration component 22 uses the relevant image finding information and text to access a medical encyclopedia and image library and look up relevant background information, diagnoses, etc., which is inserted into the template as well.

In another embodiment, the reasoning engine 20 evaluates placeholders in the identified template to determine what information is desired or needed to fill out the template. The reasoning engine 20 identifies image features and text corresponding to the placeholders and inserts the information where appropriate. Additionally, the information integration component 22 retrieves and inserts background information from the image library 24 and/or from the text library 26, such as a medical encyclopedia.

In another embodiment, prior images of the patient are included in the custom report 28 to permit a reviewer to analyze treatment progress, such as tumor growth or reduction. The reasoning engine also provides suggestions for future imaging protocols or studies.

In yet another embodiment, the reasoning engine 20 incorporates links to related information into the custom report. For instance, links to published articles, other patient cases, and the like may be inserted into the report. In another embodiment, links are included that point to additional information (e.g., omitted images, text, etc.) not included in the report, to facilitate locating the additional information at a later time, such as for re-evaluation of a diagnosis or the like.

FIG. 2 is an illustration of the reasoning engine 20, which receives patient-specific information and infers or identifies a suitable report template for a desired medical report. The reasoning engine 20 includes and/or accesses one or more information databases, such as a picture archiving and communication system (PACS) 50, a Center for Information Technology (CIT) medical database 52, a diagnostic decision support database 54, such as STATdX, and/or a web-based picture archiving and communication system 56, such as MyPACS. An imaging component 58 performs anatomical analysis 60 and image finding extraction 62 on received patient images to identify image findings (e.g., anatomical features, anomalies, etc.) that are used to assist in identifying an appropriate report template. In one embodiment, a post-processing algorithm is run on the image or image data to identify or emphasize abnormalities. For example, the algorithm can analyze lung images to identify and mark (e.g., circle) potential lung nodules. The anatomical information and image finding information is received by a computer-aided detection component 64, such as a CADx system, where a lesion detection and classification algorithm 66 is executed, as well as a volume analysis algorithm 68 (e.g., on an image volume or the like).

A text analysis component 70 executes an ontology-based reasoning algorithm 72 or technique on text retrieved from one or more of the databases as well as text in the patient's medical history (e.g., entered by a clinician or the like and stored to memory). “Ontology,” as used herein, relates to an exhaustive hierarchical organization of medical information (e.g., a database) including all relevant entities and their relations. Information from the text analysis component 70 is provided to the CADx component 64 to assist in lesion detection and classification and volume analysis. Additionally, information from each of the imaging component 58 and the text analysis component 70 is fed to a clinical application 74 that retrieves a report template (e.g., from the RTD 21 of FIG. 1) based on the received image and textual information. Information from the CADx component 64 is fed to a clinical application 76 that provides decision support for the physician.

FIG. 3 is an illustration of the information integration component 22, which assists the reasoning engine 20 in integrating patient specific information such as patient images, extracted text from medical records, user-entered information, and the like with reference information such as web links, encyclopedic information, etc., germane to the report. The information integration component 22 includes background information 90 that is stored in, for example, a unified medical language system (UMLS) or a foundational model of anatomy (FMA) database, which is anchored to target information 92 (e.g., stored in a memory comprising a medical encyclopedia or the like) and to source information (e.g., stored patient records and/or images). The information integration component 22 makes inferences to facilitate mapping the patient source information 94 to the target information 92. Once mapped, the target information (e.g., gold-standard cases and/or images, encyclopedic background information, etc.,) is inserted into the report template at pre-specified fields or locations to generate the custom report.

It will be understood that the various system components described herein with regard to FIGS. 1-3, including the reasoning engine 20, include one or more processors or computers that execute computer-executable instructions and/or algorithms stored to persistent memory for performing the various actions and providing the various functions described herein.

According to an example, a report template is automatically retrieved for an imaging study of an adult patient with symptoms including headache, vomiting, and nausea. A radiologist is requested to perform and examine a brain MRI T1-weighted scan of the patient. In this example, the reasoning engine 20 automatically extracts clinical information such as “headache, vomit, nausea” in the patient record, as well as information from the imaging order (e.g., reasons for the study or image). The terms appearing in the patient record and the imaging order are looked up in a medical ontology (e.g., SNOMED or the like), and identified terms related to clinical signs and symptoms are used in identifying one or more suitable report templates in the RTD 21.

The reasoning engine 20 performs automatic annotation of the anatomy in the T1-weighted image by adapting an annotated shape-model using a model-based segmentation technique or algorithm. Furthermore, the reasoning engine 20 analyzes properties of the resulting volumetric annotations, for instance the volumes of the lateral ventricles and the third ventricle. The reasoning engine 20 performs brain tissue classification and volume measurement algorithms, and employs computer-aided diagnosis (CAD) systems to obtain possible image findings.

During classification, manual inspection may be desired. The radiologist indicates areas of interest and provides image findings in addition to those provided by the reasoning engine 20. The radiologist selects the lateral ventricles (e.g., using a user input toll such as a mouse, a stylus, etc.), and the system displays an image volume of the lateral ventricles of the current patient and generates statistics. The reasoning engine 20 generates suggestions based on a comparison of the patient images to standard images, such as whether the lateral ventricles are enlarged, and provides a confidence indicator for the suggestion. The radiologist may add, for example, a textual description such as “abnormal enlargement of lateral ventricles” as one image finding.

The resulting information, i.e. the clinical signs and symptoms and image findings, are used to query the reasoning engine 20, which maps patient-specific information to report templates to retrieve an appropriate report template. In reporting, the radiologist issues a command to start the reporting process and the reasoning engine 20 provides a list of identified report templates. In one embodiment, the image and text retrieval component 26 includes one or more medical encyclopedias that contain description of various diagnoses and their report templates. For instance, if there are two matching diagnosis entries in the encyclopedia, such as “normal pressure hydrocephalus” and “obstructive hydrocephalus”, then the reasoning engine 20 suggests a report template based on how well each entry matches the current case. The reasoning engine 20 suggests the report template corresponding to the better-matching diagnosis to the radiologist for the current case. The radiologist optionally can choose a different report template when desired.

To further this example, a suggestion for a report template for obstructive hydrocephalus requires a clinical finding “nausea” and a T1-weighted MR image finding of “abnormal enlargement of lateral ventricles”, among other findings. The reasoning engine 20 compares the report template and finds matches for previously extracted clinical findings and imaging findings. The reasoning engine 20 automatically inserts the identified clinical and image findings to the report template in pre-specified fields. For other clinical and/or image findings, placeholders or fields are created automatically for the radiologist to fill in. For obstructive hydrocephalus, an entry might be “thinned and upward stretched corpus callosum.” This entry may be checked and an example image may be added by the radiologist before the report is submitted.

The filling of placeholders can be performed manually or automatically by image processing or CAD algorithms. For findings that cannot always be clearly determined, the template may contain a likelihood or probability value to be filled out by the reader. Additionally or alternatively, the reasoning engine 20 may propose alternative (imaging) studies to increase confidence in a particular diagnosis. As placeholders are manually filled in, the text is analyzed and appropriate reference information, as described above, is automatically added to the report.

To assist the radiologist and/or a reader of the report, the template may be further enriched by the radiologist bay adding additional information from the encyclopedia (references to gold-standard cases, studies, etc.).

The systems and methods disclosed herein can be implemented in Philips PACS systems, servers that store diagnostic information, medical workstations, or any other system that provides database services.

The term “computer-readable medium” or “memory” as used herein refers to a storage means for information encoded in a form which can be scanned or sensed by a machine or computer and interpreted by its hardware and/or software.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

Having thus described the preferred embodiments, the invention is now claimed to be:

1. A medical report generation system (10), including:
a patient medical record database that stores one or more patient records;
a text extraction component (18) that extracts, structures, and encodes clinical information in the one or more patient records;
reasoning engine (20) that analyzes the extracted clinical information, identifies a reason for a medical report generation request, analyzes the one or more patient images, and suggests a pre-generated report template based on the identified reason; and
an information integration component (22) that integrates patient-specific information (94) and background information (90, 92) into the report template in pre-specified fields to generate a custom report (28).

2. The system according to claim 1, wherein the reasoning engine (20) further includes:
an imaging component (58) that analyzes anatomical features in one or more patient images and extracts relevant image findings therefrom;
a text analysis component (70) that executes an ontology-based reasoning algorithm that identifies relevant text from the extracted text for inclusion in the custom report (28); and
a computer-aided detection (CADx) component (70) that analyzes image volumes and identifies lesions in the one or more patient images.

3. The system according to claim 2, wherein the reasoning engine (20) further includes:
a first clinical application (74) that receives image finding information from the imaging component (58) and relevant text from the text analysis component (70) and retrieves a report template as a function of the received information;
a second clinical application (76) that receives identified lesion information from the CADx component (64) and provides decision support information to a user to assist in diagnosis.

4. The system according to claim 1, wherein the text extraction component (18) is at least one or a medical language extraction and encoding (MedLEE) component or a medical natural language processing component.

5. The system according to claim 1, wherein the information integration component (22) includes a background database (90) that is accessed by the reasoning engine (20) to make inferences regarding a mapping of patient source data (94) to target data (92).

6. The system according to claim 5, wherein the background database (90) includes one or more of a unified medical language system (UMLS) database and a foundational model of anatomy (FMA) database.

7. The system according to claim 5, wherein the patient source data (94) includes one or more of a patient image and a patient medical record.

8. The system according to claim 5, wherein the target data (92) includes information from a medical encyclopedia.

9. The system according to claim 1, wherein the patient medical record database inlcudes one or more of a picture archiving and communication system database (50), a Center for Information Technology medical database (52), and a web-based picture archiving and communication system database (56).

10. A method of generating a custom radiology report (28) using the system according to claim 1, including:
extracting textual information related to reasons for generating the report (28) from received clinical and diagnostic information;
performing a table lookup to identify an appropriate report template based on the extracted textual information;
identifying image features in a patient image;
detecting and classifying one or more lesions in the patient image using the identified image features; and
inserting image feature information and extracted textual information into the report template at pre-specified placeholders.

11. The method according to claim 10, further including:
retrieving background information and inserting the background information into the report template.

12. The method according to claim 11, wherein the background information includes one or more of a standard image and encyclopedic medical text.

13. A method of generating a custom radiology report (28) using, including:
extracting textual information related to reasons for generating the report (28) from received clinical and diagnostic information;
performing a table lookup to identify an appropriate report template based on the extracted textual information;
identifying image features in a patient image;
detecting and classifying one or more lesions in the patient image using the identified image features; and
inserting image feature information and extracted textual information into the report template at pre-specified placeholders

14. The method according to claim 13, further including:
retrieving a standard image corresponding to the patient image from an image library; and
inserting the standard image into the report template.

15. The method according to claim 14, further including:
retrieving text germane to the custom report (28) from an electronic medical encyclopedia; and
inserting the text into the report template.

16. The method according to claim 13, further comprising:
accessing patient records in a medical record database;
employing ontology-based reasoning to extract information from the patient records; and
inserting information extracted from the patient records into the custom report (28).

17. The method according to claim 16, wherein the medical record database is at least one of a picture archiving and communication system (PACS) database and a web-based picture archiving and communication system (MyPACS) database.

18. The method according to claim 13, further including:
executing a computer-aided diagnosis algorithm that generates one or more diagnosis suggestions based on the extracted textual information and the identified image features; and
inserting the one or more suggested diagnoses into the custom report (28).

19. The method according to claim 18, further including:
prompting a user to manually insert additional information into the custom report (28).

20. A processor (12) or computer-readable medium (14) configured to execute the method of claim 13.
